(19) United States
(12) Patent Application Publication
(10) Pub. No.: US 2015/0096927 A1
(43) Pub. Date: Apr. 9, 2015

(54) FILTERING SYSTEM

(71) Applicant: Joseph Masters Packhem, Elmhurst, IL (US)

(72) Inventor: Joseph Masters Packhem, Elmhurst, IL (US)

(21) Appl. No.: 14/510,716

(22) Filed: Oct. 9, 2014

Related U.S. Application Data
(60) Provisional application No. 61/888,818, filed on Oct. 9, 2013.

(51) Int. Cl. G21F 9/06; G21F 3/00; B01D 35/143; B01D 35/157; B01D 35/26

(52) U.S. Cl. CPC G21F 9/06; B01D 35/1573; B01D 35/26; B01D 35/143; G21F 3/00
USPC 210/85; 210/257.1

(57) ABSTRACT

A filtering system includes a container assembly configured to receive a radioactive fluid contaminated with radioactive particles. The container assembly includes a radiation shielding assembly configured to contain radiation produced by the radioactive fluid. A delivery system is coupled to the container assembly and configured to remove the radioactive fluid from the container assembly. A filter assembly coupled to the delivery system and configured to remove all or a portion of the radioactive particles included within the radioactive fluid, wherein the filter assembly includes: a screen assembly including a plurality of passages that are sized to filter the radioactive particles from the radioactive fluid, thus producing a filtered radioactive fluid.

### RELATED APPLICATION

This application claims the benefit of U.S. Provisional Patent Application No. 61/888,818, filed on 9 Oct. 2013 and entitled “The invention is a system to remove radium from fluids”.

### TECHNICAL FIELD

This disclosure relates to filtering systems and, more particularly, to filtering systems for filtering radioactive contaminants from fluids.

### BACKGROUND

Unfortunately, water supplies are often contaminated. For example, tsunamis may strike areas that contain nuclear power plants. Accordingly, if the radiation containment systems utilized in those nuclear power plants fail, ground water supplies may be contaminated with radioactive contaminants. Accordingly, the need exists for a system that may easily and inexpensively filter radioactive contaminates from ground water.

### SUMMARY OF DISCLOSURE

In one implementation, a filtering system includes a container assembly configured to receive a radioactive fluid contaminated with radioactive particles. The container assembly includes a radiation shielding assembly configured to contain radiation produced by the radioactive fluid. A delivery system is coupled to the container assembly and configured to remove the radioactive fluid from the container assembly. A filter assembly coupled to the delivery system and configured to remove all or a portion of the radioactive particles included within the radioactive fluid, wherein the filter assembly includes: a screen assembly including a plurality of passages that are sized to filter the radioactive particles from the radioactive fluid, thus producing a filtered radioactive fluid.

One or more of the following features may be included. The radioactive fluid may be a water-based radioactive fluid. The plurality of passages may be large enough to allow the passage of water molecules and small enough to prohibit the passage of the radioactive particles. The radioactive particles may include radium particles. The filtered radioactive fluid may be a non-radioactive fluid. The delivery system may include a pump assembly. The filter assembly may be configured to be removable from the delivery system. The filter assembly may include one or more valve assemblies configured to temporarily isolate the filter assembly from the delivery system, thus allowing the filter assembly to be removed from the delivery system. The filter assembly may be configured to allow a determination to be made concerning a level of radioactive particle contamination of the filter assembly. The radiation shielding assembly may include one or more of: a metallic shield assembly; and a masonry shield assembly. The metallic shield assembly may include a lead-based shield assembly.

In another implementation, a filtering system includes a container assembly configured to receive a water-based, radioactive fluid contaminated with radioactive particles. The container assembly includes a radiation shielding assembly configured to contain radiation produced by the radioactive fluid. A delivery system is coupled to the container assembly and configured to remove the radioactive fluid from the container assembly. A filter assembly is coupled to the delivery system and configured to remove all or a portion of the radioactive particles included within the radioactive fluid. The filter assembly includes: a screen assembly including a plurality of passages that are large enough to allow the passage of water molecules and small enough to prohibit the passage of the radioactive particles, thus producing a filtered radioactive fluid.

One or more of the following features may be included. The radioactive particles may include radium particles. The filtered radioactive fluid may be a non-radioactive fluid. The delivery system may include a pump assembly.

In another implementation, a filtering system includes a container assembly configured to receive a radioactive fluid contaminated with radioactive particles. The container assembly includes a radiation shielding assembly, including one or more of a metallic shield assembly and a masonry shield assembly, configured to contain radiation produced by the radioactive fluid. A delivery system is coupled to the container assembly and configured to remove the radioactive fluid from the container assembly. A filter assembly is coupled to the delivery system and configured to remove all or a portion of the radioactive particles included within the radioactive fluid. The filter assembly includes: a screen assembly including a plurality of passages that are sized to filter the radioactive particles from the radioactive fluid, thus producing a filtered radioactive fluid. One or more valve assemblies are configured to temporarily isolate the filter assembly from the delivery system, thus allowing the filter assembly to be removed from the delivery system. The filter assembly is configured to allow a determination to be made concerning a level of radioactive particle contamination of the filter assembly.

One or more of the following features may be included. The radioactive fluid may be a water-based radioactive fluid. The plurality of passages may be large enough to allow the passage of water molecules and small enough to prohibit the passage of the radioactive particles. The radioactive particles may include radium particles. The filtered radioactive fluid may be a non-radioactive fluid. The delivery system may include a pump assembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of filtering system according to an implementation of the present disclosure;

FIG. 2 is a diagrammatic view of a container assembly included within the filtering system of FIG. 1 according to an implementation of the present disclosure;

FIG. 3 is a diagrammatic view of a filter assembly included within the filtering system of FIG. 1 according to an implementation of the present disclosure;

FIG. 4 is a diagrammatic view of a screen assembly included within the filtering system of FIG. 1 according to an implementation of the present disclosure;

FIG. 5 is another diagrammatic view of the screen assembly included within the filtering system of FIG. 1 according to an implementation of the present disclosure; and

FIG. 6 is another diagrammatic view of the filter assembly included within the filtering system of FIG. 1 according to an implementation of the present disclosure.

Like reference symbols in the various drawings indicate like elements.

### DETAILED DESCRIPTION OF THE PREFERRED EMBODIMENTS

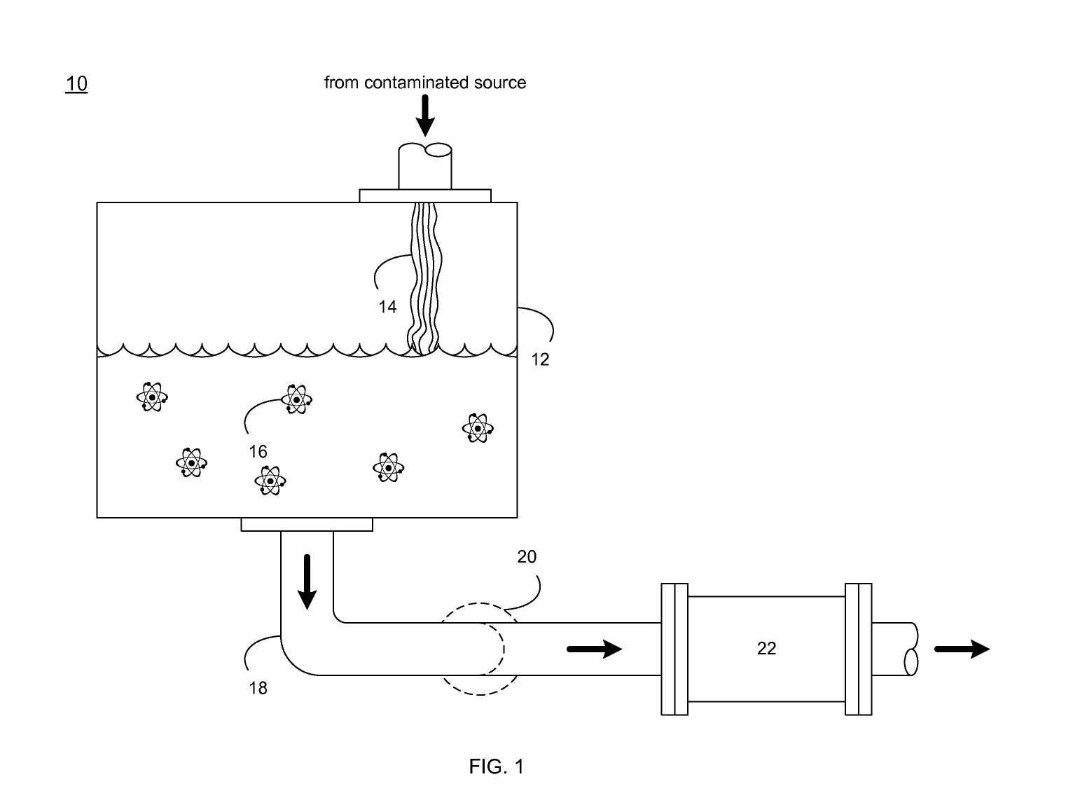

Referring to FIG. 1, there is shown filtering system 10. Filtering system 10 may include container assembly 12 configured to receive a radioactive fluid (e.g., radioactive fluid 14) contaminated with radioactive particles (e.g., radioactive particle 16). Radioactive fluid 14 may be a water-based radioactive fluid, such a ground water that is contaminated with the above-described radioactive particles (e.g., radioactive particle 16). For example, radioactive fluid 14 may be contaminated ground water that is drawn (i.e., pumped) from a contaminated aquifer. An example of the radioactive particles (e.g., radioactive particle 16) may include but is not limited to radium particles.

Delivery system 18 may be coupled to container assembly 12 and may be configured to remove radioactive fluid 14 from container assembly 12. For example, radioactive fluid 14 may gravity drain using hydrostatic pressure from container assembly 12 via delivery system 18. Alternatively, delivery system 18 may include pump assembly 20 that may be configured to aid in the removal of radioactive fluid 14 from container assembly 12. Accordingly, pump assembly 20 may be configured to generate negative pressure (i.e., suction) that extracts radioactive fluid 14 from container assembly 12.

Filter assembly 20 may be coupled to delivery system 18 and may be configured to remove all or a portion of the above-described radioactive particles (e.g., radioactive particle 16) included within radioactive fluid 14.

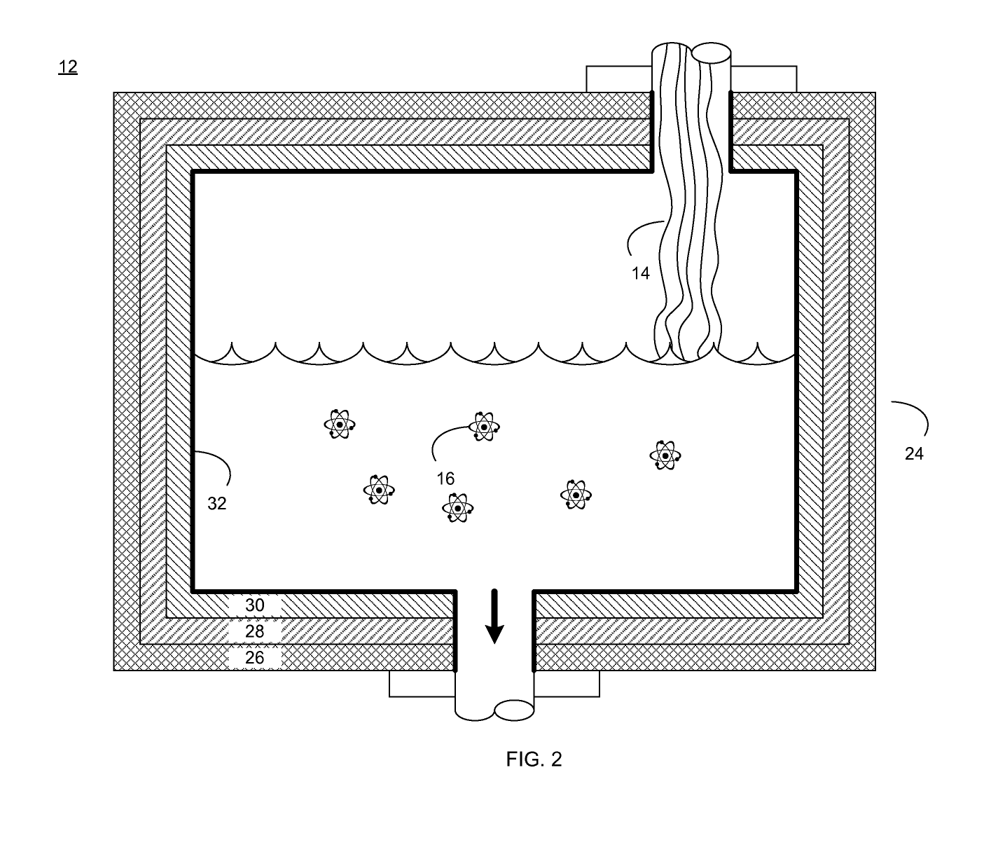

Referring also to FIG. 2, container assembly 12 may include radiation shielding assembly 24 configured to contain the radiation produced by radioactive fluid 14 and the radioactive particles (e.g., radioactive particle 16) included within radioactive fluid 14. Radiation shielding assembly 24 may be a multipart shield assembly that included multiple shield layers, such as metallic shield assemblies (e.g., lead or steel shield assemblies) and masonry shield assemblies (e.g., brick, block or concrete shield assemblies). For example, container assembly 12 may be configured to include brick shield assembly 26, lead shield assembly 28, and cinderblock shield assembly 30. Container assembly 12 may also include waterproof liner 32 that is configured to contain radioactive fluid 14.

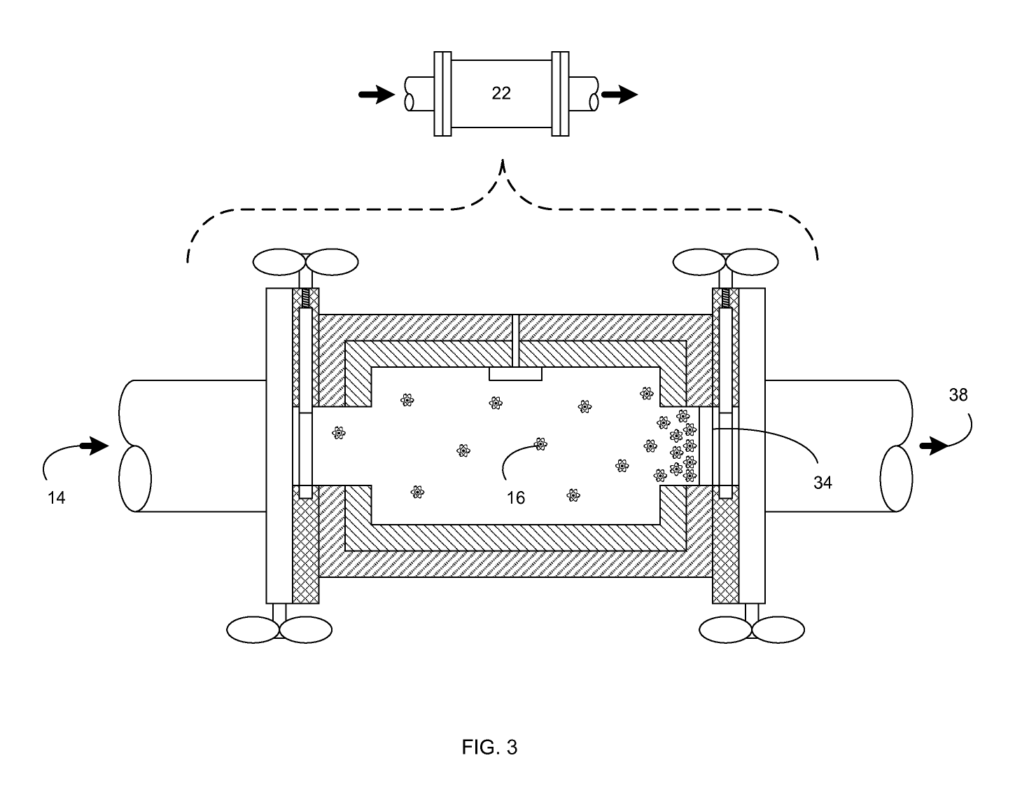

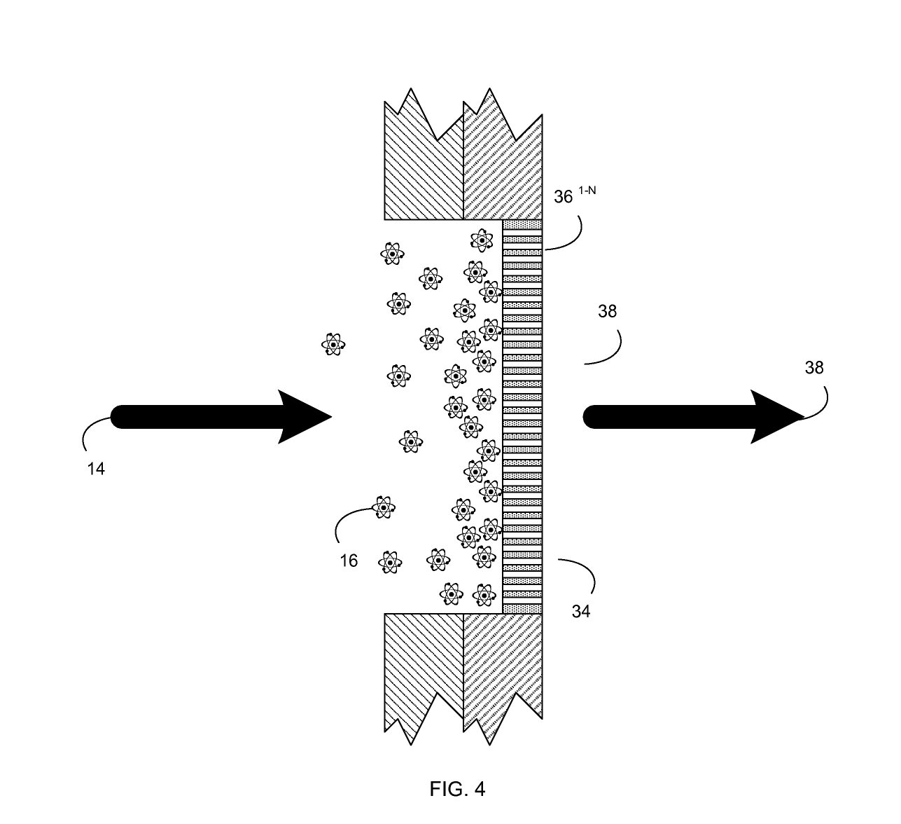

Referring also to FIGS. 3-4, filter assembly 22 may include screen assembly 34 including a plurality of passages 36^{1-N} that are sized to filter the above-described radioactive particles (e.g., radioactive particle 16) from radioactive fluid 14, thus producing filtered radioactive fluid 38. Filtered radioactive fluid 38 may be a non-radioactive fluid (depending upon the efficiency of filter assembly 22). Alternatively, filtered radioactive fluid 38 may be a partially radioactive fluid, wherein filter assembly 22 only removes a portion (but not all) of the above-described radioactive particles (e.g., radioactive particle 16) from radioactive fluid 14. Filtered radioactive fluid 38 may be stored in a storage tank (not shown) for later consumption and/or use.

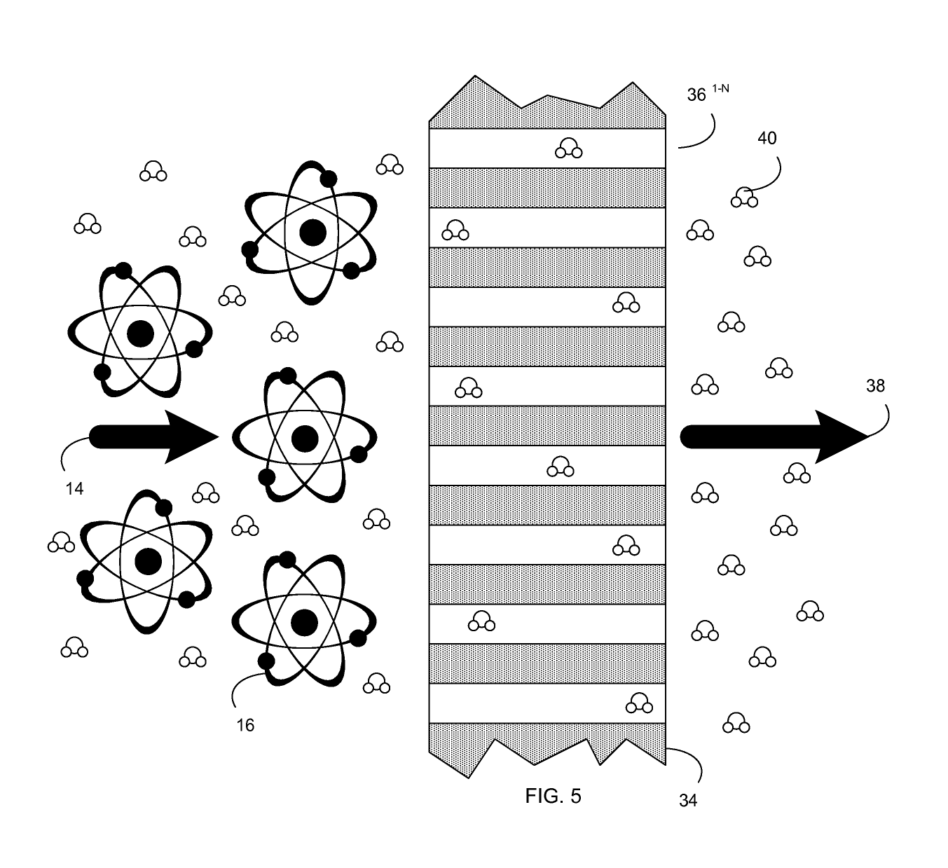

Referring also to FIG. 5, plurality of passages 36^{1-N} may be large enough to allow the passage of water molecules (e.g., water molecule 40) through filter assembly 22 (specifically screen assembly 34), but small enough to prohibit the passage of the above-described radioactive particles (e.g., radioactive particle 16). For example and as is known in the art, a radium atom has a diameter of 0.460 nanometers and a water molecule has a maximum width of 0.275 nanometers. Accordingly, plurality of passages 36^{1-N} included within screen assembly 34 may have a diameter of e.g., 0.350 nanometers, thus allowing for the passage of the smaller water molecules (e.g., water molecule 40) while prohibiting the passage of the larger radium atoms (e.g., radioactive particle 16). While the diameter of plurality of passages 36^{1-N} are described above as being 0.350 nanometers, this is for illustrative purposes only, as (for this particular application) the diameter of plurality of passages 36^{1-N} can fall anywhere in the range of <0.460 nanometers through 0.275 nanometers. Further, in the event that the above-described radioactive particles (e.g., radioactive particle 16) included within radioactive fluid 14 have a different size, this range may be adjusted accordingly.

As is known in the art, an example of screen assembly 34 may include but is not limited to a film-based screen (e.g., of silicon or some other material), which may be constructed e.g., by accelerating a sample of the atoms/molecules designed to pass through the screen to a velocity sufficient to penetrate the screen, and having them strike the screen, thus creating plurality of passages 36^{1-N} that allow for the passage of such molecules/atoms.

Continuing with the above-example, a screen of silicon may be constructed. The specific thickness of screen assembly 34 may be adjusted to provide the required level of structural integrity in light of the diameter/area of screen assembly 34. Accordingly, if screen assembly 34 is one inch in diameter, it may be thinner than if screen assembly 34 is twelve inches in diameter. Once the appropriate thickness of screen assembly 34 is determined, water molecules (i.e., the molecule that is allowed to pass through screen assembly 34 in this example) may be accelerated via magnetic fields to a velocity sufficient to penetrate screen assembly 34, thus producing plurality of passages 36^{1-N}.

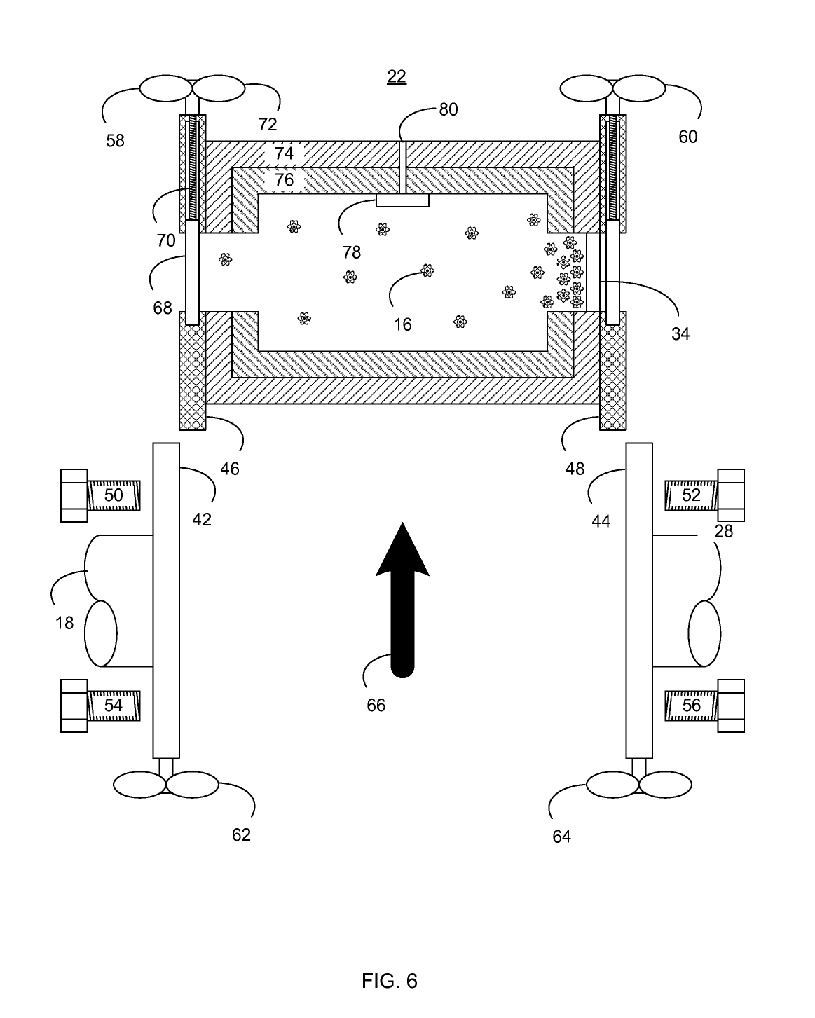

Referring also to FIG. 6, filter assembly 22 may be configured to be removable from delivery system 18. Accordingly, one or more flange, bolt and/or clamp assemblies may be configured to allow filter assembly 22 to be removable from delivery system 18. For example, delivery system 18 may include one or more flange assemblies (e.g., flange assemblies 42, 44). Further, filter assembly 22 may include one or more matching flange assemblies (e.g., flange assemblies 46, 48) that are configured to releasably engage the flange assemblies (e.g., flange assemblies 42, 44) included on delivery system 18. Additionally, one or more bolt assemblies (e.g., bolt assemblies 50, 52, 54, 56) may releasably engage flanges 42, 46 and flanges 44, 48).

Filter assembly 22 may further include one or more valve assemblies (e.g., valve assemblies 58, 60, 62, 64) that may be configured to temporarily isolate filter assembly 22 from delivery system 18, thus allowing filter assembly 22 to be removed from delivery system 18 in the direction of e.g., arrow 66. One or more of valve assemblies 58, 60, 62, 64 may be included within/coupled to delivery system 18. Accordingly and through the use of valve assemblies 58, 60, 62, 64, filter assembly 22 may be removed from delivery system 18 without spillage of radioactive fluid 14 and/or filtered radioactive fluid 38. Specifically, valve assemblies 58, 60 may be configured to seal filter assembly 22 to prevent the spillage of the radioactive particles trapped within filter 22. Further, valve assembly 62 may be configured to prevent the spillage of radioactive fluid 14 from delivery system 18 and valve assembly 64 may be configured to prevent the spillage of filtered radio active fluid 38.

One or more of valve assemblies 58, 60, 62, 64 may be configured to include moveable plate 68 operably connected to threaded rod 70 that is rotatable via knob 72. Accordingly by rotating knob 72, plate 68 may be positioned to seal (in this example) the inlet side of filter assembly 22.

Filter assembly 22 may be configured in a manner similar to container assembly 12 and may include one or more shield assemblies. For example and in this particular embodiment, filter assembly 22 is shown to include two shield assemblies, namely lead shield assembly 74 and ceramic shield assembly 76. Delivery system 18 may be shielded in a fashion similar to that of filter assembly 22 and container assembly 12.

Filter assembly 22 may be configured to allow a determination to be made concerning the level of radioactive particle contamination of the fluid trapped within filter assembly 22. For example, filter assembly may include sensor assembly 78 and/or port assembly 80 that may allow for a determination to be made concerning the level of contamination of the fluid within filter assembly 22. Specifically, sensor assembly 78 may be a micro-cantilever sensor that includes a plurality of micro-cantilevers (not shown). As is known in the art, micro-cantilevers will oscillate at a known frequency, wherein the frequency varies depending upon the mass of the micro-cantilever. Accordingly, if the micro-cantilevers are coated with a substance (e.g., a polymer) that is configured to attract e.g., radium atoms, as these radium atoms attach to the polymer-coated micro-cantilever, the mass of the micro-cantilever increases and the oscillation frequency decreases. Accordingly and by measuring the reduction in this oscillation frequency, the level of contamination of the fluid within filter assembly 22 may be determined.

Alternatively, port assembly 80 may be configured to allow a pH test to be performed on the fluid within filter assembly 22. As is known in the art, the level of radioactive contamination of the fluid within filter assembly 22 may be determined based upon the pH of the fluid within filter assembly 22.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A filtering system comprising:
a container assembly configured to receive a radioactive fluid contaminated with radioactive particles, wherein the container assembly includes a radiation shielding assembly configured to contain radiation produced by the radioactive fluid;
a delivery system coupled to the container assembly and configured to remove the radioactive fluid from the container assembly;
a filter assembly coupled to the delivery system and configured to remove all or a portion of the radioactive particles included within the radioactive fluid, wherein the filter assembly includes:
a screen assembly including a plurality of passages that are sized to filter the radioactive particles from the radioactive fluid, thus producing a filtered radioactive fluid.

2. The filtering system of claim 1 wherein the radioactive fluid is a water-based radioactive fluid.

3. The filtering system of claim 2 wherein the plurality of passages are large enough to allow the passage of water molecules and small enough to prohibit the passage of the radioactive particles.

4. The filtering system of claim 1 wherein the radioactive particles include radium particles.

5. The filtering system of claim 1 wherein the filtered radioactive fluid is a non-radioactive fluid.

6. The filtering system of claim 1 wherein the delivery system includes a pump assembly.

7. The filtering system of claim 1 wherein the filter assembly is configured to be removable from the delivery system.

8. The filtering system of claim 7 wherein the filter assembly includes one or more valve assemblies configured to temporarily isolate the filter assembly from the delivery system, thus allowing the filter assembly to be removed from the delivery system.

9. The filtering system of claim 1 wherein the filter assembly is configured to allow a determination to be made concerning a level of radioactive particle contamination of the filter assembly.

10. The filtering system of claim 1 wherein the radiation shielding assembly includes one or more of:
a metallic shield assembly; and
a masonry shield assembly.

11. The filtering system of claim 1 wherein the metallic shield assembly includes a lead-based shield assembly.

12. A filtering system comprising:
a container assembly configured to receive a water-based, radioactive fluid contaminated with radioactive particles, wherein the container assembly includes a radiation shielding assembly configured to contain radiation produced by the radioactive fluid;
a delivery system coupled to the container assembly and configured to remove the radioactive fluid from the container assembly;
a filter assembly coupled to the delivery system and configured to remove all or a portion of the radioactive particles included within the radioactive fluid, wherein the filter assembly includes:
a screen assembly including a plurality of passages that are large enough to allow the passage of water molecules and small enough to prohibit the passage of the radioactive particles, thus producing a filtered radioactive fluid.

13. The filtering system of claim 12 wherein the radioactive particles include radium particles.

14. The filtering system of claim 12 wherein the filtered radioactive fluid is a non-radioactive fluid.

15. The filtering system of claim 1 wherein the delivery system includes a pump assembly.

16. A filtering system comprising:
a container assembly configured to receive a radioactive fluid contaminated with radioactive particles, wherein the container assembly includes a radiation shielding assembly, including one or more of a metallic shield assembly and a masonry shield assembly, configured to contain radiation produced by the radioactive fluid;
a delivery system coupled to the container assembly and configured to remove the radioactive fluid from the container assembly;
a filter assembly coupled to the delivery system and configured to remove all or a portion of the radioactive particles included within the radioactive fluid, wherein the filter assembly includes:
a screen assembly including a plurality of passages that are sized to filter the radioactive particles from the radioactive fluid, thus producing a filtered radioactive fluid, and
one or more valve assemblies configured to temporarily isolate the filter assembly from the delivery system, thus allowing the filter assembly to be removed from the delivery system;
wherein the filter assembly is configured to allow a determination to be made concerning a level of radioactive particle contamination of the filter assembly.

17. The filtering system of claim 16 wherein the radioactive fluid is a water-based radioactive fluid.

18. The filtering system of claim 17 wherein the plurality of passages are large enough to allow the passage of water molecules and small enough to prohibit the passage of the radioactive particles.

19. The filtering system of claim 16 wherein the radioactive particles include radium particles.

20. The filtering system of claim 16 wherein the filtered radioactive fluid is a non-radioactive fluid.

21. The filtering system of claim 16 wherein the delivery system includes a pump assembly.
